(19) United States
(12) Patent Application Publication
(10) Pub. No.: US 2021/0302544 A1
(43) Pub. Date: Sep. 30, 2021

(54) ACQUISITION OF DISTANCE MEASUREMENT DATA

(71) Applicant: SICK AG, Waldkirch (DE)

(72) Inventors: Matthias HONAL, Waldkirch (DE); Raphael ENGESSER, Waldkirch (DE); Fabian BECK, Waldkirch (DE)

(21) Appl. No.: 17/214,116

(22) Filed: Mar. 26, 2021

(30) Foreign Application Priority Data
Mar. 27, 2020 (EP) 20166102.2

(51) Int. Cl. G01S 7/481; G01S 17/89; G06N 3/04; G06N 3/08; G06T 7/11

(52) U.S. Cl. CPC G01S 7/4817; G01S 17/89; G06N 3/0454; G06T 2207/20081; G06T 7/11; G06T 2207/20084; G06N 3/08

(57) ABSTRACT

An optoelectronic sensor (10) for detecting distance measurement data of objects in a monitored area (20), the optoelectronic sensor (10) comprising a measuring unit having a light transmitter (12) for transmitting transmitted light (16) at a plurality of angles and a light receiver (26) for generating a received signal, and a control and evaluation unit (36) configured to acquire the distance measurement data from the received signal with an angular resolution and a time resolution over the plurality of angles and a plurality of measurement repetitions, to arrange the distance measurement data into an image (46) of pixels representing distance values arranged over a dimension of an angle and a dimension of time, and to evaluate the image (46) using a machine learning image classification method (48) in order to assign a class to the pixels.

The invention relates to an optoelectronic sensor and a method for detecting distance measurement data of objects in a monitoring area.

A widely used type of sensor for distance measurement is a laser scanner. A light beam generated by a laser periodically scans a monitored area using a rotating mirror. The light is remitted by objects in the monitored area and is evaluated in the laser scanner. The angular position of the deflection unit is used to determine the angular position of the object, and the light time of flight is used to determine the distance of the object from the laser scanner based on the speed of light. With the angle and distance data, the location of an object in the monitoring area is detected in two-dimensional polar coordinates. The positions of objects or their contours can be determined.

Recently, the conventional laser scanners using a rotating mirror have been joined by variants with a rotating measuring head with co-rotating laser and light receiver, multi-beam systems for extending the measuring range beyond a single scanning plane, and increasingly so-called solid-state systems where the moving parts are replaced by microsystems or electronic controls. A common summarizing term for these sensors for the acquisition of distance measurement data is LiDAR (Light Detection and Ranging).

In many applications, there is interference in the measurement environment of a LiDAR sensor. This applies to outdoor applications with environmental influences such as fog, spray, dust, rain or snow, for example in traffic monitoring, but also to applications in dusty environments of mining or machinery, for example in a sawmill or the manufacturing industry. The challenge is to suppress the environmental influences in the distance measurement data and at the same time continue to generate reliable measured values of the objects.

A conventional approach to improve measurement under environmental influences is based on filters that detect and eliminate typical interference. Examples are so-called particle filters, echo filters or fog filters. Particle filters detect temporally and spatially separated measuring points. Thus, larger or static objects are retained, but at the same time large-area interference caused by fog or spray or the like are not filtered. Echo filters can be used in so-called multi-echo laser scanners that measure distances to a plurality of objects arranged one behind the other along the line of sight. This is combined with heuristics, such as that in fog the first peak in the received signal is caused by fog droplets and the last peak is caused by the actual target object behind. The echo filter is insensitive to large-area interference, but the heuristics do not always match the actual target object, for example in case of edge scans where the transmitted light impinges on an edge between two objects. A fog filter suppresses measured values whose intensity is smaller or equal to the typical intensity of fog at the measured distance. The fog filter detects low-intensity interference independent of the extent of the interference. However, it is difficult to correctly set the respective distance-dependent fog threshold taking into account the energy loss of the light signal through the fog, and some distant and in particular dark objects are falsely filtered.

Each filter only models specific aspects of possible environmental influences. There is no such thing as one universal filter, designing and parameterizing the filter and selecting a suitable filter combination while weighing up the advantages and disadvantages in a specific application situation requires in-depth expert knowledge. Despite this effort, considerable compromises still often have to be made.

As an alternative to filtering interference, it is also conceivable to create models of the objects to be detected, such as vehicles in traffic classification or excavator shovels in mining. Such an approach is discussed in the paper of T. G. Phillips, “Determining and verifying object pose from LiDAR measurements to support the perception needs of an autonomous excavator,” The University of Queensland, 2016. If there is sufficient matching between the model and the measurement data, the object is considered to be detected, and all measurement data that the model does not explain are interpreted as interference. Of course, this also applies to hard objects and not just environmental influences. In addition, the manual model creation again requires a lot of effort.

The prior art furthermore discusses the application of learning methods to measurement data of a LiDAR system. The paper X.-F. Hana, J. S. Jin, J. Xie, M.-J. Wang and W. Jiang, “A comprehensive review of 3D point cloud descriptors,” February 2018. [Online] Available: http://arxiv.org/pdf/1802.02297v1 is concerned with feature-based learning methods for classification. In particular in the context of autonomous driving and with the emergence of high-resolution 3D-LiDAR scanners, the possibilities of deep neural networks are increasingly discussed. The LiDAR data are supplied as a depth map, i.e. an image whose pixels encode the measured distance instead of the usual color or gray value information.

In A. Milioto, I. Vizzo, J. Behley, and C. Stachniss, “RangeNet++: Fast and Accurate LiDAR Semantic Segmentation,” http://www.ipb.uni-bonn.de/wp-content/papercite-data/pdf/milioto2019iros.pdf, 2019 a point-by-point classification is made. An object or more specifically pedestrian detection is known from G. Melotti, A. Asvadi, and C. Premebida, “CNN-LIDAR pedestrian classification: combining range and reflectance data,” in 2018 IEEE International Conference on Vehicular Electronics and Safety (ICVES), Madrid, September 2018-September 2018, pp. 1-6. A multi-channel image is used whose pixels contain not only depth information but also intensity information of the light received at the respective location. M. Velas, M. Spanel, M. Hradis, and A. Herout, “CNN for Very Fast Ground Segmentation in Velodyne LiDAR Data,” September 2017. [Online] Available: http://arxiv.org/pdf/1709.02128v1 describes a ground detection system. In V. Vaquero, A. Sanfeliu, and F. Moreno-Noguer, “Deep Lidar CNN to Understand the Dynamics of Moving Vehicles,” in 2018 IEEE International Conference on Robotics and Automation (ICRA), Brisbane, QLD, May 2018-May 2018, pp. 4504-4509 a motion analysis is performed wherein two successively acquired laser scans are combined into one image with four channels in order to obtain the motion information.

Most of the methods and networks proposed in the literature are optimized for 3D-LiDAR data and are not easily transferable to a 2D laser scanner with only one scanning plane.

In Á. M. Guerrero-Higueras et al, “Tracking People in a Mobile Robot From 2D LIDAR Scans Using Full Convolutional Neural Networks for Security in Cluttered Environments,” Frontiers in neurorobotics, vol. 12, p. 85, 2018, the measured angle and distance data are entered directly into a pixel grid for a point-by-point classification of people. This results in a sparse image where the pixels at a location of a scan point obtain the value one or the intensity value of the scan point, and all other positions obtain the value zero.

Alternatively, the deep neural networks themselves can be adapted so that they can handle a 2D scan as input data instead of an image. Such a method is used for example in L. Beyer, A. Hermans, and B. Leibe, “DROW: Real-Time Deep Learning based Wheelchair Detection in 2D Range Data,” March 2016. [Online] Available: http://arxiv.org/pdf/1603.02636v2 to detect persons and wheelchairs.

In C. R. Qi, H. Su, K. Mo, and L. J. Guibas, “PointNet: Deep Learning on Point Sets for 3D Classification and Segmentation,” Proceedings of the IEEE conference on computer vision and pattern recognition, 2017, no image but the raw disordered point cloud is used as input of the deep neural network. These methods are suitable for both 2D and 3D-LiDAR data, but require specifically adapted neural networks.

None of these methods is used for the detection of environmental influences. They also appear to have only limited suitability for this purpose, since they process spatial information. For many kinds of interference, such as rain or snow, however, the temporal behavior would also be of interest, which goes largely unnoticed in the conventional approaches.

It is therefore an object of the invention to improve the evaluation of the distance measurement data of a sensor of the type as outlined above.

This object is satisfied by an optoelectronic sensor, in particular a laser scanner, for detecting distance measurement data of objects in a monitored area, the optoelectronic sensor comprising a measuring unit having a light transmitter for transmitting transmitted light into the monitored area at a plurality of angles and a light receiver for generating a received signal from received light that is received from the monitoring area from a plurality of angles, and comprising a control and evaluation unit configured to acquire the distance measurement data from the received signal with an angular resolution and a time resolution over the plurality of angles and a plurality of measurement repetitions by determining a light time of flight, to arrange the distance measurement data into an image of pixels representing distance values arranged over a dimension of an angle and a dimension of time, and to evaluate the image using a machine learning image classification method in order to assign a class to the respective pixels.

The object is also satisfied by a method for detecting distance measurement data of objects in a monitored area, wherein transmitted light is transmitted into the monitored area at a plurality of angles and a received signal is generated from received light received from the monitored area from a plurality of angles, wherein the distance measurement data are acquired from the received signal with an angular resolution and time resolution over the plurality of angles and a plurality of measurement repetitions by determining a light time of flight, wherein the distance measurement data are arranged into an image of pixels representing distance values over a dimension of an angle and a dimension of time, and the image is evaluated using a machine learning image classification method in order to assign a class to the respective pixels.

The optoelectronic sensor can preferably be called a LiDAR sensor in the sense explained in the introduction. Throughout this specification, the terms preferably or preferred refer to advantageous, but completely optional features. A measuring unit transmits light and generates a received signal from the returning light. In order to obtain a spatial resolution over several directions or angles, it is scanned using any scanning method, ranging from a physical rotation or swivel movement over deflecting microsystems to purely electronic control. At least some angles can preferably be scanned simultaneously in a multi-beam system.

A control and evaluation unit generates the distance measurement data by evaluating the received signal with a light time of flight method. The angle is varied with the measurements, this is also called a scan. Using measurement repetitions, i.e. a plurality of scans at successive points in time, the distance measurement data are resolved both in terms of angle and time. The angle and time raster or grid does not necessarily have to be regular, but preferably at least the angle raster in itself should not change over the measurement repetitions. The control and evaluation unit can be implemented on a digital component such as a microprocessor and be located internally, but also at least partially or completely outside a sensor housing, in particular in a connected computer, network or cloud. For example, the tasks could be distributed in such a way that the distance measurement data itself is generated internally using time-of-flight methods, but further processing is performed externally.

The invention starts from the basic idea of arranging the distance measurement data to form an image and thus making it accessible to the various machine learning methods for image processing. To this end, angle and time are used as dimensions or axes of the image. In a 2D-LiDAR acquisition, this results in a two-dimensional image in which, without any limitation of generality, the X-axis corresponds to the angle and the Y-axis to time. The value of each pixel corresponds to the distance measured for that angle and time. In 3D-LiDAR acquisition, an additional axis is added for a second angle, typically the elevation angle with respect to a mean scanning plane. The measurement data of a multi-beam laser scanner, for example, can be processed either like an image from 3D-LiDAR data or like several images from 2D-LiDAR data per beam.

The image allows time-varying LiDAR data to be evaluated using a machine learning image classification method. The pixels are assigned to a respective class, which in particular is used to detect environmental influences.

The invention has the advantage of enabling a particularly robust classification that takes into account the specific characteristics of a specific application. Due to the data-based approach, this is possible without in-depth technical knowledge, since the properties are implicitly learned from the data. In contrast to the learning methods discussed in the introduction, no classical image with spatial resolution on all axes is classified, but the time component is included as an axis of the image. Thus, histories can be evaluated, which can play a major role in particular in the case of environmental influences. A special selection, adjustment or combination of suitable filters no longer needs to be made.

The image classification method preferably distinguishes an object from interference due to environmental influences, wherein the environmental influences in particular comprise at least one of dust, spray, fog, rain or snow. Thus, the classification aims at assigning the pixels an additional property as interference or real object, preferably binary in exactly these two classes. Then, for example, a downstream logic for object classification, collision avoidance or other applications can use the class information of the pixels to provide more robust and reliable results or to make decisions.

The control and evaluation unit preferably is configured to discard distance measurement data of pixels classified as interference. The pixels to be discarded can be set to a corresponding value for example of zero or NIL. Instead of completely discarding pixels with interference, they can be evaluated in a different way downstream, for example with a lower contribution in a downstream object evaluation.

The control and evaluation unit preferably is configured to determine an intensity value in addition to the distance values. The intensity corresponds to the level of the received signal, in particular in the region of a pulse echo detected during the time-of-flight method, and is also called remission value, brightness value or RSSI (Received Signal Strength Indicator). This results in a multimodal image or multi-channel image with two measured values per pixel. The intensity values can also be taken into account by generating a further image for the intensity values analogous to the one with the distance values and feeding it to the image classification method either simultaneously or successively.

The control and evaluation unit preferably is configured to determine a plurality of distances for the pixels. In a pulse-based time-of-flight method, there may be a plurality of received pulses or echoes, from each of which a distance can be measured. This applies, for example, to a measurement through a glass pane or other (semi-)transparent object to another object behind it, where both the glass pane and the object provide a distance each. In the context of the invention, the semi-transparent objects in particular are interference, i.e. a fog echo or an echo caused by raindrops and the like. By measuring a plurality of distances, a multi-channel image is obtained whose channels correspond to the plurality of distances, for example a three-channel image when considering three echoes. If another quantity like intensity is measured, the number of channels doubles, for example resulting in a six-channel image. This includes additional information that is also used in the classical approaches: A particle filter evaluates the distance, a fog filter the intensity and an echo filter the multiple echoes, and the multichannel image contains all the underlying information. The existing learning methods usually also allow the analysis of multi-channel images, so that known and proven classification methods or deep neural networks can preferably be used. Instead of a multichannel image, the analysis of a plurality of images with the information of some or single channels is conceivable.

The control and evaluation unit preferably is configured to interpolate distance measurement data for pixels for the arrangement to an image in order to also obtain distance values for angles and/or times for which originally no measurements were made. A LiDAR system, in particular a laser scanner, typically generates the measured values not in a regular arrangement but as a point cloud. The mutual angular distances can be quite irregular. The measured distances, and as far as relevant the measured intensities, are interpolated to a uniform angular resolution for the image according to this preferred embodiment. The measurement period and the time interval between two measurement repetitions is typically constant, but may also vary according to the invention. Even with a constant measurement period, the time resolution of the distance measurement data does not have to be regular. For example, instead of continuously containing the last n measurements, the history to be taken into account can be only every i-th scan or a selection thinned out with increasing age of the scans.

The control and evaluation unit preferably is configured to calculate distance measurement data from the image at the angles and/or times at which a light time of flight was determined, and to assign a respective class to the distance measurement data from the pixel or pixels which are in the vicinity of the respective angle and/or time. This in a way is the inversion of the interpolation of the previous paragraph. The classifications of the pixels from the arrangement within the image are transferred back to the original distance measurement data. Thus the format of the distance measuring data, now classified, again corresponds to the original one, and this can simplify subsequent evaluations and/or make already existing subsequent evaluations more easily accessible. Since the angles of the image and the distance measurement data can be offset with respect to one another, the class of the closest angle in the image or, for example, a class according to a majority decision in neighboring angles is assigned.

The image classification method preferably assigns a class only to pixels at a fixed time. Thus, while the input is an entire image including a history, only a classification limited to a fixed time is generated as the output. The fixed time corresponds to a row (or, depending on the convention, a column) of the image. Usually, there is no interest in classifying the entire history, but only a certain measurement at a certain time, with the history ultimately only providing auxiliary data. The image classification method can be simplified and accelerated by limiting the image classification method to a fixed time only. The fixed time preferably is the present, i.e. the most recent measurement or scan, in particular in order to meet real-time or quasi real-time requirements. Without real-time requirements, it would also be conceivable to choose a different fixed time. Then, the classification is based partly on a history and partly on a future in any ratio including not taking history or future into account.

The image classification method preferably comprises a deep neural network. These structures may perform even complex image classifications very reliably. Alternative image classification methods of machine learning are support vector machines or decision trees, which use the distance and intensity values of the current pixel and its neighborhood with appropriate normalization as features.

The image classification method preferably is trained in advance with images where the class for the pixels is known. Such labelled or annotated images specify what is a relevant interference and what is an object. The structure of the training images preferably corresponds to the structure of images from distance measurement data that are later fed to the image classification method. Training images therefore have at least one angle axis and a time axis, and the pixels encode distance measurement values and possibly intensities.

The known class preferably is predetermined by selective interference in certain sub-areas of the monitoring area. In this way, training images can be generated that show specific aspects to be learned. In addition, the annotation of the images is simplified, since the location of the interference is largely known. The resulting classification can manually be updated. It is also conceivable to classify the training images entirely by hand, which does not have to be done pixel by pixel, but for example by encircling certain regions, or an automatic pre-segmentation and manual selection of segments that belong to objects or interference. Another way to obtain annotated training images is to apply one of the conventional methods mentioned in the introduction to suitable images using filters or object models. Due to the training, the image classification method can later on generalize to other applications and/or interference situations.

The image classification method preferably is optimized for small errors for a specific class. This makes use of a further advantage of at least some machine learning image classification algorithms that prefer a certain class and assign this class very precisely, which is associated with larger error for the other class that is deliberately accepted. For example, as many object pixels as possible are detected as belonging to the object class, at the price that some part of the interference is also classified as objects. This could for example be used in collision protection, where interference that is incorrectly treated as an object causes a loss in availability, but never constitutes a safety problem. In the opposite case, some object points are sorted out as interference, but the remaining object points are very reliable. This may for example be used to measure or detect a vehicle during traffic monitoring, where interference treated as object points could lead to gross misinterpretations.

The optoelectronic sensor preferably is configured as a 2D laser scanner. The measuring unit in particular may comprise a movable deflection unit for periodically scanning the monitoring area, the optoelectronic sensor thus being a classic laser scanner having a swiveling or rotating mirror, or a movable measuring head. However, the scanning method along only one line for the acquisition of 2D-LiDAR data can also be achieved in other ways, for example by microsystems or electronic control. The known learning methods for LiDAR data discussed in the introduction use a depth map with two lateral space dimensions X, Y and the measured distance as Z axis. They are therefore not applicable to 2D LiDAR data. According to the invention, time forms an additional axis and thus creates a data structure that is actually not an image in the conventional sense, but can be processed like an image. Thus, all findings and existing implementations of machine learning image processing methods, in particular convolutional or deep neural networks, can be applied to a 2D laser scanner.

The method according to the invention can be modified in a similar manner and shows similar advantages. Further advantageous features are described in an exemplary, but non-limiting manner in the dependent claims following the independent claims.

The invention will be explained in the following also with respect to further advantages and features with reference to exemplary embodiments and the enclosed drawing. The Figures of the drawing show in:

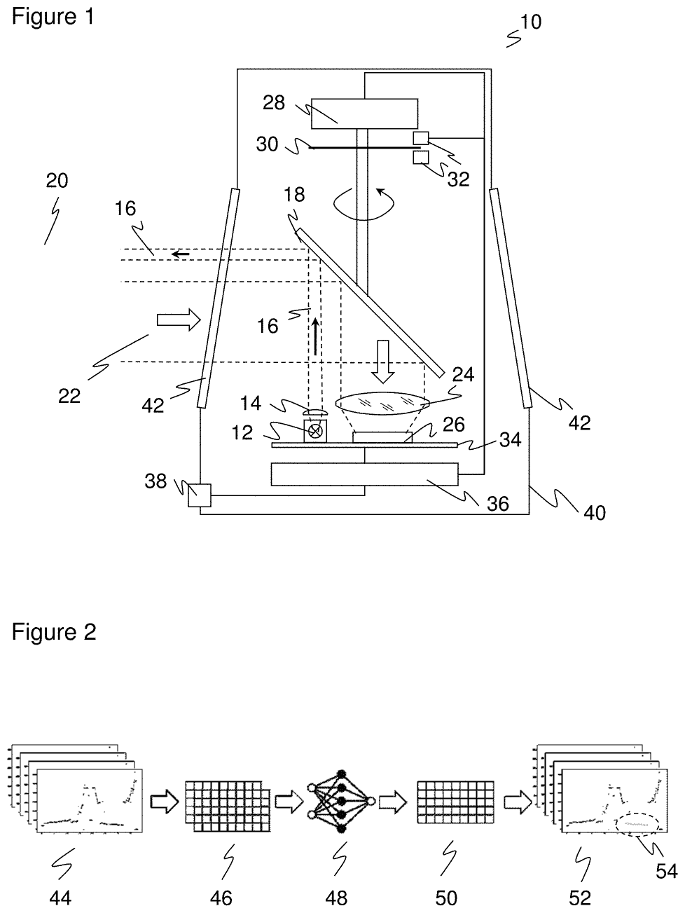

FIG. 1 a schematic representation of a laser scanner;

FIG. 2 an overview of a classification model for LiDAR data, in particular of a laser scanner;

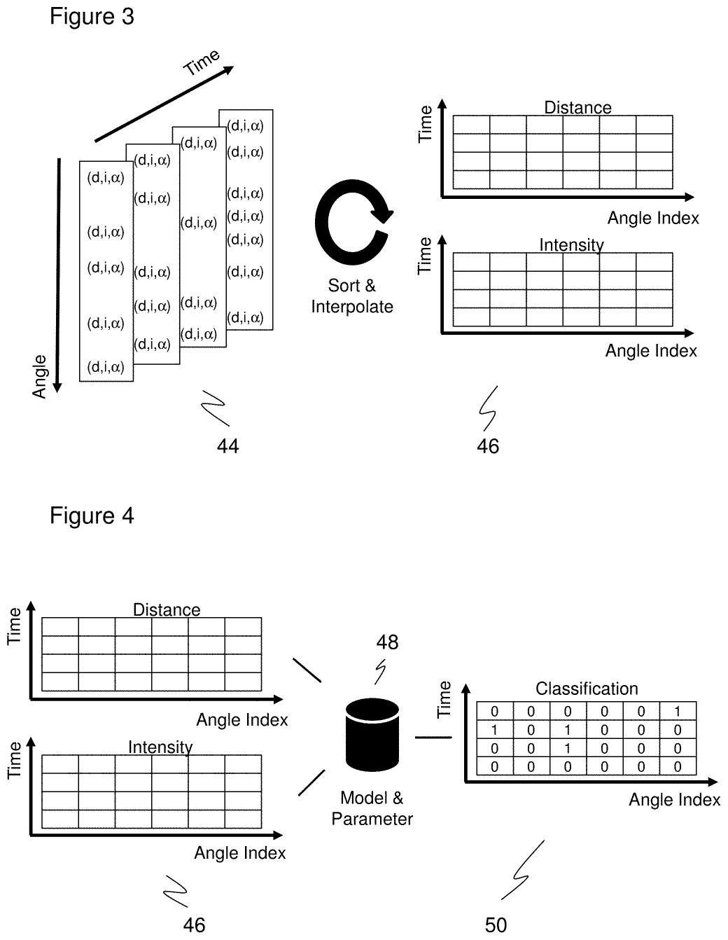

FIG. 3 an illustration of the preparation of LiDAR data as an image;

FIG. 4 an illustration of the pixelwise classification of images from LiDAR data using a machine learning method;

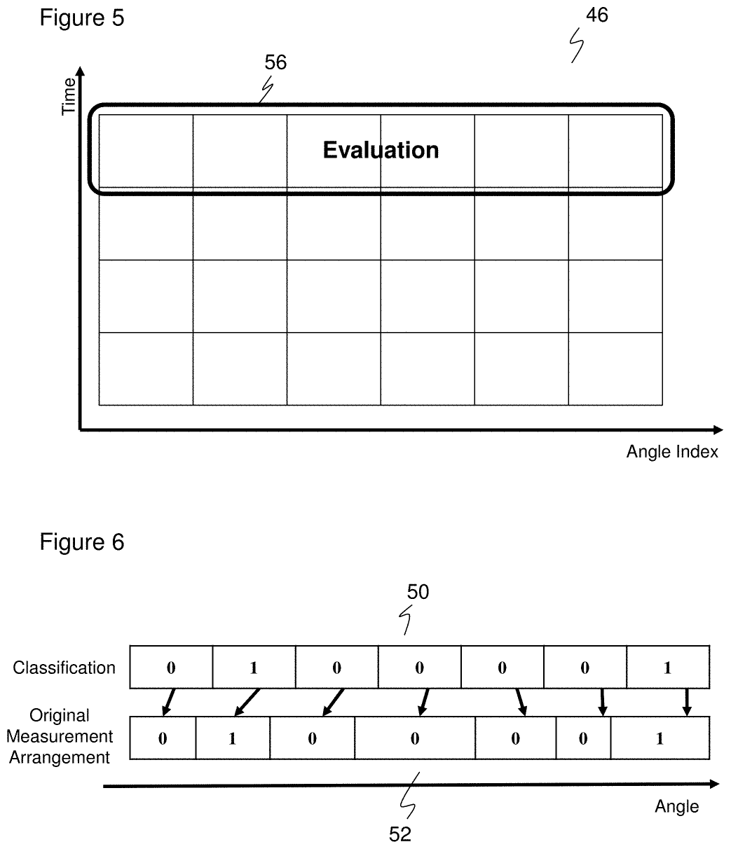

FIG. 5 another illustration of the pixelwise classification, showing a time range to which the pixelwise classification is limited;

FIG. 6 an illustration of transferring classifications related to an image line back to LiDAR data;

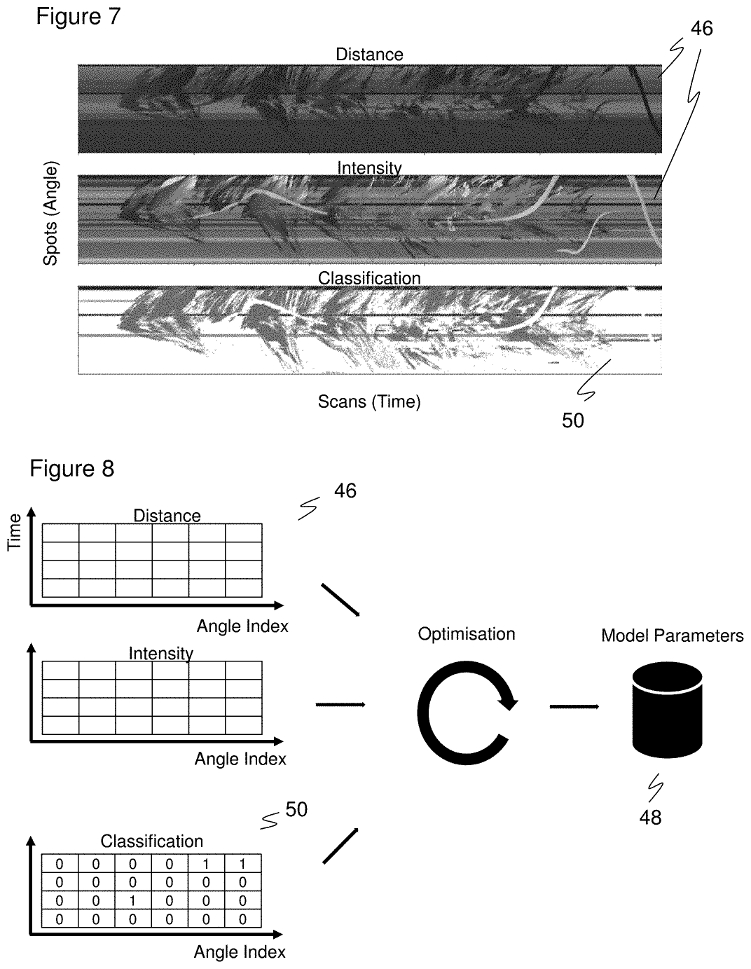

FIG. 7 an exemplary representation of a multi-channel training image with distance and intensity information and predefined associated classes; and

FIG. 8 an illustration of learning the machine learning method with a training image.

FIG. 1 shows a schematic sectional view of a 2D laser scanner 10 as an example of an optoelectronic sensor for the acquisition of LiDAR data or distance measurement data. In the laser scanner 10, a light transmitter 12, for example with a laser light source, generates a transmitted light beam 16 using transmission optics 14. The transmitted light beam 16 is deflected into a monitoring area 20 at a deflection unit 18. If the transmitted light beam 16 impinges on an object in the monitoring area 20, remitted light 22 returns to the laser scanner 10 and is detected via the deflection unit 18 and receiving optics 24 by a light receiver 26, for example a photodiode, an APD (Avalanche Photo Diode) or a SPAD arrangement (Single-Photon Avalanche Photo Diode).

The deflection unit 18 in this embodiment is configured as a rotating mirror that rotates continuously driven by a motor 28. The respective angular position of the motor 28 and thus the deflection unit 18 is detected by an encoder that for example comprises a code disk 30 and a fork light barrier 32. The transmitted light beam 16 generated by the light transmitter 12 thus sweeps over the monitoring area 20 generated by the rotational movement. Instead of a rotating mirror, it is also possible to configure the deflection unit 18 as a rotating optical head wherein light transmitter 12 and/or light receiver 26 and possibly further elements are accommodated. The design of transmission optics 14 and receiving optics 24 can also be varied, for example by using a beam-shaping mirror as a deflection unit, a different arrangement of the lenses, or additional lenses. In particular, laser scanners are also known in an autocollimation arrangement. In the embodiment shown, light transmitter 12 and light receiver 26 are mounted on a common circuit board 34. This is also only an example, because separate circuit boards as well as other arrangements can be provided, for example with a mutual height offset.

If the light receiver 26 receives remitted light 22 from the monitoring area 20, the angular position of the deflection unit 18 measured by the encoder 30, 32 can be used to determine the angular position of the object in the monitoring area 20. In addition, the light time of flight from the transmission of a light signal to its reception after reflection at the object in the monitoring area 20 preferably is determined, and the distance of the object from the laser scanner 10 is deduced using the speed of light.

This distance measurement using a time-of-flight method is carried out in a control and evaluation unit 36, which is connected to the light transmitter 12, the light receiver 26, the motor 28 and the encoder 32. Thus two-dimensional polar coordinates of all objects in the monitoring area 20 are available via angle and distance.

The control and evaluation unit 36 can be connected via an interface 38 to higher-level systems, such as a dedicated evaluation computer, a higher-level controller, a local network or a cloud. The evaluation using a time-of-flight method and the further evaluation of the distance measurement data yet to be described can be distributed virtually arbitrarily between the internal control and evaluation unit 36 and external computing units. Preferably, however, at least the distance measurement using a time-of-flight method is carried out internally in the control and evaluation unit 36, and it is also conceivable to provide the entire evaluation internally. In this case, the control and evaluation unit preferably comprises not only one, but a plurality of computing components, such as FPGAs (Field-Programmable Gate Array), ASICs (Application-Specific Integrated Circuit), microprocessors or GPUs (Graphics Processing Unit). All the internal functional components mentioned above are preferably arranged in a housing 40, which has a front window 42 in the area of the light exit and light entry.

The respective polar coordinates obtained by the scanning correspond to one sampling point. For each rotation of the deflection unit, a scanning plane of the monitoring area 20 is scanned, and a corresponding point cloud is generated. One such measurement is also called a scan. In a plurality of revolutions and thus measurement repetitions, a plurality of scans is created in a temporal sequence. For a 2D laser scanner, the individual scans are each 2D-LiDAR data, where one dimension is the angle and the other dimension is the distance measured for that angle. There are also multi-beam laser scanners scanning a set of planes at different elevation angles, or laser scanners having variable orientation in elevation. Accordingly, 3D-LiDAR data are acquired, with two dimensions of the rotation angle and the elevation angle and one dimension of the measured distance associated with a pair of angles. A transformation from polar or spherical coordinates to Cartesian coordinates is possible.

The invention covers both 2D-LiDAR data and 3D-LiDAR data. Furthermore, the scanning principle is not limited to the described mechanical rotation. Instead, microsystems, such as MEMS mirrors, or electronic controls like in a phased optical array or acousto-optical modulators can be used. Furthermore, an array on the transmission side, such as a VCSEL line (Vertical Cavity Surface-Emitting Laser) or VSCEL matrix, and/or an array on the receiving side, in particular a SPAD line or SPAD matrix, with selection of the respective scan direction by activating the corresponding individual elements, preferably matching pairs on the transmission and receiving side, is conceivable. Finally, it is conceivable to acquire a plurality of scan directions simultaneously. According to the invention, the laser scanner 10 preferably is used outdoors (Outdoor-LiDAR) or in dusty environments, so that the interference detection now to be described can show its strengths.

FIG. 2 shows an overview of a classification model that assigns a class to a respective scan point, in particular one of two classes “interference” and “(hard or real) object” in a binary or digital classification. The following description is based on the example of a neural network as a classifier in a preferred embodiment, in particular a convoluted neural network or deep neural network. Other methods of machine learning, such as decision trees or support vector machines, would also be conceivable. The procedure has two phases:

In a training phase, which will be explained in more detail below with reference to FIGS. 7 and 8, an image classification method, in this embodiment a deep neural network, is trained for determining the parameters of the image classification method with LiDAR data where the desired classification is known. The necessary definition of the respective classes (labeling, annotation) is typically done manually or with manual support.

In the application phase shown in FIG. 2, the LiDAR data are classified using the trained image classification method. The individual steps will initially be explained in a summary and subsequently in more detail with reference to FIGS. 3 to 6. Starting point in this embodiment are 2D LiDAR data 44, i.e. measured distances depending on the respective angle, which are available as point clouds of a plurality of scans (shown as layers in FIG. 2) corresponding to the respective measuring times and thus including a certain history. These scans are arranged as images 46, in this example a distance image and an intensity image, alternatively only a distance image, with one axis representing the angle and the other axis representing time, and the pixels encoding the measured distance or the measured intensity at their respective angle and time. The image or the images are fed to the image classification method or deep neural network 48, which determines a pixelwise classification 50 as interference or object. It will be explained later on that preferably only an image line instead of the entire image is classified on the output side. Finally, the classification 50 is transferred back to the 2D-LiDAR data 52 where thus the classification is added. In FIG. 2, as an example, the circled part 54 of the scan points is classified as interference.

FIG. 3 illustrates the preparation of the LiDAR data 44 as an image 46, i.e. the first processing step of FIG. 2. This processing step can also be omitted or become trivial, in particular if the angular and time resolution is regular.

The LiDAR data 44 are initially available as a point cloud, which for example can be represented as vectors with distance d, intensity i and angle a. The fourth dimension is time, which is shown in FIG. 3 by the different layers. The invention is not restricted to any specific representation of the point clouds.

The angle a where a distance is measured may generally have an irregular distribution and may also differ from scan to scan. The vectors in the illustration in FIG. 3 are distributed accordingly. The measurement period or the distance between two scans on the time axis does also not have to be regular. Preferably, at least the angle distribution in each scan is the same or even regular. This simplifies interpolation and arrangement. However, even with a regular angular grid, interpolation may be necessary to adjust the resolution.

By re-sorting and interpolation, the LiDAR data are arranged in a regular pixel grid of an image 46. An angular index can be considered in the image because the angular distances are now equidistant. A special feature of this image is that it is not simply the result of a transformation of polar coordinates into Cartesian coordinates. Rather one axis, in this example the Y-axis, is a time axis corresponding to scans at different times. The image is no conventional depth map, but completely different physical quantities are chosen as image dimensions, namely, angle and time. Due to this data representation, both spatial and temporal information is taken into account in a classification, leading to better classification results. At the same time, the format as an image allows the use of image classification methods instead of having to design a specific classifier for point clouds.

According to FIG. 3, two images are generated, a distance image and an intensity image (remission, RSSI). The respective value of a pixel is the distance or the intensity measured at that angle and time, possibly obtained by interpolation from the neighborhood. Instead of two images, a multi-channel image having a pair (distance, intensity) per pixel could be generated, or the intensity could be ignored in yet another alternative. Conversely, further measured variables of a multichannel image or an additional image are conceivable.

An example for additional measured variables is a multi-echo system. This means that a scanning beam not only determines the distance to one object, but to a plurality objects arranged one behind the other along the scanning beam. Typically, this happens when a part of the transmitted light beam 16 is reflected by a partially transparent object, such as a fog particle or rain droplet, and another part is reflected by an object farther away. When using a pulse-based time-of-flight method, this results in a plurality of received pulses, peaks or echoes in the received signal, each allowing a distance measurement. Thus, just like a pair (distance, intensity), a pair (first distance, second distance) can be processed as a multi-channel image or as a pair of images. If the intensity is considered in addition, two times two channels or images result, and even more when the system is a multi-echo system rather than a two-echo system.

FIG. 4 illustrates the actual classification of the image 46, i.e. the second processing step of FIG. 2. Here, the deep neural network 48 is shown as a generic parameterized model to once again emphasize that other machine learning methods can also be used. The images 46 with the distance and intensity data as input data of the deep neural network 48 can be limited to certain lines to consider only a certain history, for example of four scans as shown or any other number of scans.

The deep neural network 48 predicts a classification 50 pixel by pixel. As an example, “1” represents an interference class and “0” represents an object class. The U-Net used for image segmentation has proven to be a preferred implementation of the deep neural network. It is described in O. Ronneberger, P. Fischer, and T. Brox, “U-Net: Convolutional Networks for Biomedical Image Segmentation,” May 2015, [Online] Available: http://arxiv.org/pdf/1505.04597v1

FIG. 5 again shows an image 46 to illustrate a time range 56 to which the classification 50 can optionally be limited. In the selected representation with time on the Y-axis, each image line represents a scan at a certain measurement time. The classification is usually only required for the present, i.e. the current scan and thus the top image line of the time range 56. Based on that, scans can be evaluated in real time or quasi real time.

Unlike conventional image segmentation, the output thus is preferably limited to one image line. The input, however, is an entire image including the current scan to be evaluated and a certain history of additional scans. This classification is performed for each measurement time or scan. Alternatively, an interference evaluation can also be carried out only cyclically or randomly at certain measurement times. By limiting the output to only one image line, the number of free parameters can be reduced and the quality of the classification model can be improved with respect to speed, amount of training data or accuracy. However, it is not excluded to classify all pixels of image 46 and, if necessary, to only afterwards limit the readout or further processing to a partial area. A combination of the classification results for pixels that belong to the same measurement time from a plurality of images is also possible, for example by forming a majority.

FIG. 6 illustrates a transfer of the classification 50 determined for the format of images 46 back to LiDAR data, i.e. the third processing step of FIG. 2. This processing step is optional, depending on how the downstream data processing expects the information to be prepared. The advantage of a transformation back to LiDAR data is that the output format corresponds to that of the original LiDAR data, and therefore existing downstream evaluations may be able to cope with it in a familiar way more easily and with fewer adjustments. For example, the classification result is additionally appended to the vectors of the point cloud.

The classification 50 of the deep neural network 48 is only available in the uniform format of images 46. As discussed with reference to FIG. 3, the LiDAR data itself are generally measured as a point cloud at irregular angular intervals. For the transfer of classification 50 back to the LiDAR data, each point or vector of the scans is assigned a classification result that is derived from the neighboring angles. This is indicated by arrows in FIG. 6. One possibility is to find the closest angle of the image to the angle of the vector, and to copy the classification result from this pixel. Another possibility is to make a majority decision of the classification results in a certain angular neighborhood of the image to the respective angle of the vector. Other types of interpolation are also conceivable.

The representation in FIG. 6 is limited to one image line or one scan at a fixed time in accordance with the above explanations with reference to FIG. 5. The transfer back to LiDAR data is thus carried out line by line or per scan or measurement just like the classification 50 itself. Alternatively, it would be conceivable to transfer a classification 50 for an entire image 46 back to the underlying scans, but then effectively a different history is considered for each scan. In this case, a transfer corresponding to FIG. 6 is preferably performed in the time dimension as well.

FIG. 7 shows an example of a labeled or annotated training image used to train the deep neural network 48. Such a training image includes a distance image and an intensity image 46 from LiDAR data and an associated classification 50. The distance image and the intensity image 46 are gray-coded, whereas for the classification 50 hard objects are shown in light color and interference in dark color. A plurality of scans at different successive times of the measurement are plotted along the X-axis, and on the Y-axis the distance or intensity values at the respective angle are shown for each scan. Thus, X-axis and Y-axis are interchanged as compared to the earlier representations in order to accommodate more scans for illustration purposes. The training image as shown can be interpreted in sections as a plurality of training images. Nevertheless, in practice a plurality of such images is usually required to train the deep neural network in a robust way.

Some expert knowledge is still required for the data collection of the training images, but this is more application-related and far less demanding than designing, selecting, parameterizing and combining suitable filters in the conventional way, which would also require specific knowledge of the effects of environmental influences on the hardware and software of a LiDAR system. In addition, a deep neural network is 48 more robust against scenarios that have not been expected and considered in advance. Acquiring images 46 for the training data and its labeling and annotating, i.e. specifying a desired classification 50, requires a certain amount of effort. This effort can be limited, however, by selecting scenarios with a known setting or predetermined interference in certain sub-areas. Moreover, it is not necessary to label individual pixels, but preferably entire areas, and classical filters and segmentation methods can at least make a supporting preselection.

FIG. 8 illustrates the training phase. The building blocks basically all have already been explained, the training phase merely reverses the procedure. What is unknown and to be learned during training in an optimization method are the model parameters, in particular the weights in the neural network 48, while the classification 50 is predefined. In the subsequent application phase, it is the classification 50 that is to be determined, while the model parameters are known from the training.

The invention is particularly advantageous in applications where the environment is largely known, but is nevertheless flexible in parts. An example would be traffic classification. Here, training data from different vehicles on dry and wet roads, i.e. with spray, can be recorded and manually classified. After the training, the classification allows to separate measured values of spray and measured values of vehicles, which simplifies the determination of vehicle parameters, such as height, length, width, trailer present and the like. Another example would be dust detection on trucks or excavators in mining. Here, to avoid collisions, dust clouds that can be passed through must be distinguished from hard objects which might cause a collision.

Many learning methods allow the false positive or false negative rate to be adjusted, for example by selecting suitable threshold values. In this way, the quality of the classification results can be adapted to the requirements of the application. In traffic classification, for example, it may be acceptable for measured values from the vehicle to be classified as spray, as long as only the least possible number of spray measurements are classified as vehicles. This is important for not overestimating vehicle dimensions. Conversely, in mining applications, it would be better to avoid classifying measured values from hard objects as dust, whereas a classification of a dust measured value as a hard object would be more acceptable. This would only reduce the availability of the system, but it would not lead to collisions.

Previously, it has been assumed that images 46 extend over the entire detected angle range. In order to save memory for the image classification method, it would be conceivable to define several angular ranges per scan that complement each other and possibly overlap at the edges. Furthermore, the angle only preferably directly represents the scan angle, it more generally represents a spatial dimension. Thus, it would be conceivable to convert the scans into Cartesian coordinates and to base the images on a combination of the time axis with a different spatial axis, in particular the distance.

Instead of 2D-LiDAR data, 3D-LiDAR data can also be processed. In this case, 3D images are processed, having two axes corresponding to the two angles in the original scan direction and in elevation, or corresponding Cartesian axes after conversion. The pixels, or in that case more correctly the voxels, still encode the distance and, if desired, the intensity.

In addition to the measured variables distance and intensity, other variables possibly provided by the sensor can be evaluated, such as measured value quality or ambient light level, or the multiple distances of a multi-echo system mentioned above. Then, additional images 46 or additional channels of a multichannel image including these quantities are generated. The training and classification is carried out in analogy to the above description. It is also conceivable to generate data from other sources, such as a radar or a camera after appropriate temporal and spatial registration.

1. An optoelectronic sensor (10) for detecting distance measurement data of objects in a monitored area (20), the optoelectronic sensor (10) comprising:
a measuring unit having a light transmitter (12) for transmitting transmitted light (16) into the monitored area (20) at a plurality of angles and a light receiver (26) for generating a received signal from received light (22) that is received from the monitoring area (20) from a plurality of angles
and a control and evaluation unit (36) configured to acquire the distance measurement data from the received signal with an angular resolution and a time resolution over the plurality of angles and a plurality of measurement repetitions by determining a light time of flight, to arrange the distance measurement data into an image (46) of pixels representing distance values arranged over a dimension of an angle and a dimension of time, and to evaluate the image (46) using a machine learning image classification method (48) in order to assign a class to the respective pixels.

2. The optoelectronic sensor (10) according to claim 1, which is configured as a laser scanner.

3. The optoelectronic sensor (10) according to claim 1,
wherein the image classification method (48) distinguishes an object from interference due to environmental influences.

4. The optoelectronic sensor (10) according to claim 3,
wherein the environmental influences comprise at least one of dust, spray, fog, rain or snow.

5. The optoelectronic sensor (10) according to claim 1,
wherein the control and evaluation unit (36) is configured to discard distance measurement data of pixels classified as interference.

6. The optoelectronic sensor (10) according to claim 1,
wherein the control and evaluation unit (36) is configured to determine an intensity value in addition to the distance values.

7. The optoelectronic sensor (10) according to claim 1,
wherein the control and evaluation unit (36) is configured to determine a plurality of distances for the pixels.

8. The optoelectronic sensor (10) according to claim 1,
wherein the control and evaluation unit (36) is configured to interpolate distance measurement data for pixels for the arrangement to an image (46) in order to also obtain distance values for angles and/or times for which originally no measurements were made.

9. The optoelectronic sensor (10) according to claim 1,
wherein the control and evaluation unit (36) is configured to calculate distance measurement data from the image (46) at the angles and/or times at which a light time of flight was determined, and to assign a respective class to the distance measurement data from the pixel or pixels which are in the vicinity of the respective angle and/or time.

10. The optoelectronic sensor (10) according to claim 1,
wherein the image classification method (48) assigns a class only to pixels at a fixed time.

11. The optoelectronic sensor (10) according to claim 1,
wherein the image classification method (48) comprises a deep neural network.

12. The optoelectronic sensor (10) according to claim 1,
wherein the image classification method (48) is trained in advance with images (46) where the class for the pixels is known.

13. The optoelectronic sensor (10) according to claim 12,
wherein the known class is predetermined by selective interference in certain sub-areas of the monitoring area (20).

14. The optoelectronic sensor (10) according to claim 1,
wherein the image classification method (48) is optimized for small errors for a specific class.

15. Sensor (10) according to claim 1, which is configured as a 2D laser scanner.

16. The optoelectronic sensor (10) according to claim 15,
wherein the measuring unit comprises a movable deflection unit (18) for periodically scanning the monitoring area (20).

17. A method for detecting distance measurement data of objects in a monitored area (20), wherein transmitted light (16) is transmitted into the monitored area (20) at a plurality of angles and a received signal is generated from received light (22) received from the monitored area (20) from a plurality of angles,
wherein the distance measurement data are acquired from the received signal with an angular resolution and time resolution over the plurality of angles and a plurality of measurement repetitions by determining a light time of flight, wherein the distance measurement data are arranged into an image (46) of pixels representing distance values over a dimension of an angle and a dimension of time, and the image (46) is evaluated using a machine learning image classification method (48) in order to assign a class to the respective pixels.
